(19) United States
(12) Patent Application Publication
(10) Pub. No.: US 2025/0067704 A1
(43) Pub. Date: Feb. 27, 2025

(54) PROTECTIVE MEMBRANE SYSTEM FOR A ROD-SHAPED SENSOR AND SENSOR UNIT

(71) Applicant: Endress+Hauser Conducta GmbH+Co. KG, Gerlingen (DE)

(72) Inventors: Holm Petzold, Dresden (DE); Matthäus Speck, Göpfersdorf (DE); André Pfeifer, Schkopau (DE)

(21) Appl. No.: 18/815,112

(22) Filed: Aug. 26, 2024

(30) Foreign Application Priority Data
Aug. 24, 2023 (DE) 10 2023 122 742.4

(51) Int. Cl. G01N 27/40; G01N 27/333

(52) U.S. Cl. CPC G01N 27/40; G01N 27/333

(57) ABSTRACT

The present disclosure relates to a protective membrane system for a rod-shaped sensor. comprising a membrane unit which is resilient and has a lattice structure, and a secondary fastening unit which is suitable for fastening the membrane unit to a rod-shaped sensor.

### CROSS-REFERENCE TO RELATED APPLICATION

The present application is related to and claims the priority benefit of German Patent Application No. 10 2023 122 742.4, filed on Aug. 24, 2023, the entire contents of which are incorporated herein by reference.

### TECHNICAL FIELD

The present disclosure relates to a protective membrane system for a rod-shaped sensor, and a sensor unit.

### BACKGROUND

In analytical measurement technology, especially in the fields of water management, of environmental analysis, in industry, e.g. in food technology, biotechnology, and pharmaceutics, as well as for the most varied laboratory applications, measured variables, such as the pH, the conductivity, or even the concentration of analytes, such as ions or dissolved gases in a gaseous or liquid medium, are of great importance. These measured variables can be acquired and/or monitored for example by means of electrochemical sensors, such as optical, potentiometric, amperometric, voltammetric, or coulometric sensors, or also conductivity sensors.

It is important that these sensors are as long-lasting as possible and operate extremely reliably, in all conceivable areas of application. Especially in dirty environments, the sensors must also be cleaned regularly. Therefore, the sensors should be particularly easy to clean without compromising the measurement quality.

A concrete example of a sensor in dirty environments is an ISE sensor with an ion-sensitive membrane, which is used in a sewage treatment plant to determine ammonium and nitrate, for example in what is known as an aeration tank. It is important here that no deposits form on the membrane, in order not to create any differences between the concentration in the process medium P and on the membrane. In addition to mineral deposits, for example bacteria can also settle on the surface of the membrane. In order to prevent deposits from causing irreparable damage to the membrane, the surface must be cleaned regularly. It should therefore be easily accessible and easy to clean.

### SUMMARY

It is therefore an object of the present disclosure to propose a protective membrane system which enables reliable and long-lasting use of a sensor as well as easy cleaning of the sensor, even under extremely dirty measuring conditions.

This object is achieved according to the present disclosure by a protective membrane system according to the present disclosure.

The protective membrane system according to the present disclosure comprises a membrane unit which is resilient and has a lattice structure, and a secondary fastening unit which is suitable for fastening the membrane unit to a rod-shaped sensor.

The protective membrane system according to the present disclosure enables a rod-shaped sensor to measure reliably for the longest possible period of use and to be easily cleaned. Furthermore, the protective membrane system enables an optimal compromise to be achieved between the inflow of the medium onto the sensor and the protection of the sensor against premature contamination. Especially in the case of the sensor being an ion-selective electrode, the protective membrane system ensures a balanced relationship between the inflow to and the inflow protection of the membrane.

According to one embodiment of the present disclosure, the lattice structure has meshes of a size less than 1 mm, preferably less than 500 μm.

According to a further embodiment of the present disclosure, the membrane unit comprises textile.

According to one embodiment of the present disclosure, the secondary fastening unit comprises an O-ring or a hook element.

According to one embodiment of the present disclosure, the protective membrane system further comprises an intermediate layer which is suitable for being arranged between the membrane unit and the rod-shaped sensor.

According to one embodiment of the present disclosure, the membrane unit is suitable for reducing ion transport through the membrane unit.

The aforementioned object is furthermore achieved by a sensor unit according to present disclosure.

The sensor unit according to the present disclosure comprises a sensor having a sensor body which extends along an axis and has a first end, a sensitive unit being arranged at the first end, and the first end being suitable for being immersed in a process medium and a protective membrane system according to the present disclosure. The protective membrane system being arranged at the first end and being fastened to the sensor body such that the sensitive unit is covered by the protective membrane system towards the process medium.

According to one embodiment of the present disclosure, the sensor body has a primary fastening unit which is complementary to the secondary fastening unit of the protective membrane system.

According to one embodiment of the present disclosure, the primary fastening unit is a groove in the sensor body running around the axis, and the secondary fastening unit is designed as an O-ring.

According to one embodiment of the present disclosure, the primary fastening unit comprises a hook element, and the secondary fastening unit is formed integrally with the membrane unit.

According to one embodiment of the present disclosure, the sensor comprises an ion-selective electrode, as well as an electrolyte in the sensor body, and has a discharge line arranged in the electrolyte. the sensitive unit being an ion-selective membrane which is in direct contact with the electrolyte.

### BRIEF DESCRIPTION OF THE DRAWINGS

The present disclosure is explained in more detail on the basis of the following description of the figures. In the figures:

FIG. 1 shows a schematic view, by way of example of the sensor unit according to the present disclosure,

FIG. 2 shows a voltage-time graph for a first test,

FIG. 3 shows a voltage-time graph for a second test,

FIG. 4 shows a plot of the measured voltages against the logarithm of the concentration (the unprotected electrode is corrected for the drift between the additions), and

FIG. 5 shows a schematic view of the layer structure of the protected electrode.

### DETAILED DESCRIPTION

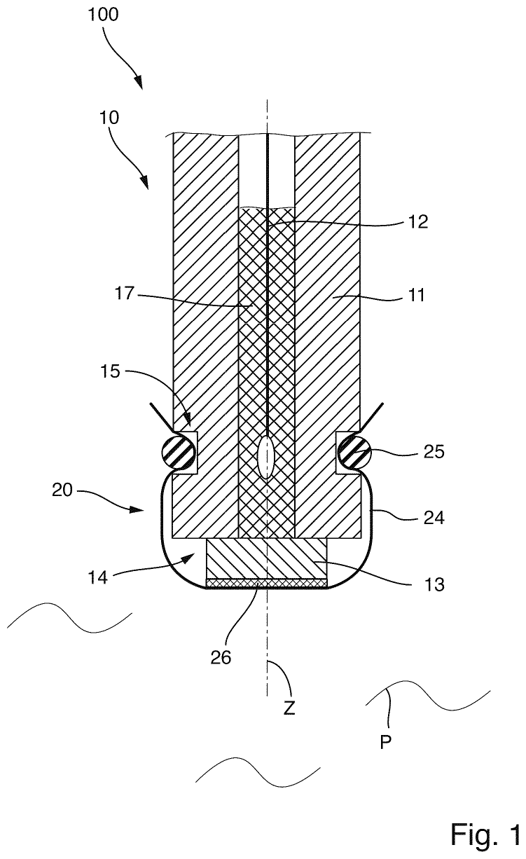

FIG. 1 shows an embodiment of the sensor unit 100 according to the present disclosure, comprising a sensor 10 and a protective membrane system 20 according to the present disclosure.

The sensor 10 comprises a sensor body 11 which extends along an axis Z and has a first end 14. Depending on the embodiment of the sensor 10, the sensor body 11 is made of, for example, PEEK plastics, ceramic, glass or metal. A sensitive unit 13 is arranged at the first end 14 of the sensor body 11. The sensitive unit 13 is preferably arranged on the front side of the sensor body 11. The sensitive unit 13 is suitable for being in contact with a process medium P. According to a first embodiment of the present disclosure, the sensitive unit 13 is an ion-selective membrane. In the case of an ion-selective membrane, this is, for example, glued or applied directly to the sensor body 11.

According to another embodiment of the present disclosure, the sensitive unit 13 is, for example, a pH membrane of a pH sensor.

According to the first embodiment of the present disclosure which is shown in FIG. 1, the sensor 10 comprises an ion-selective electrode. In this embodiment, an electrolyte 17 is arranged in the sensor body 11. The electrolyte 17 is preferably a liquid or gel-like electrolyte 17 which is arranged in a chamber in the sensor body 11. Likewise, a discharge line 12 is arranged in the electrolyte 17. The ion-selective membrane is in direct contact with the electrolyte 17. The ion-selective membrane seals the chamber of the sensor body 11, with high resistance, against the process medium, and ensures that no process medium P comes into direct contact with the electrolyte 17.

The sensor body 11 has a primary fastening unit 15. The primary fastening unit 15 is, for example, a groove in the sensor body 11 running around the axis Z. The peripheral groove is designed to accommodate an O-ring. According to an alternative embodiment of the present disclosure that is not shown, the primary fastening unit 15 comprises at least one hook element.

The protective membrane system 20 of the sensor unit 100 comprises a membrane unit 24 and a secondary fastening unit 25.

The protective membrane system 20 is suitable to be arranged at the first end 14 of the sensor body 11. The protective membrane system 20 is suitable for being fastened to the sensor body 11 with the aid of the secondary fastening unit 25 such that the sensitive unit 13 is completely covered by the protective membrane system 20.

The membrane unit 24 is resilient and has a lattice structure. The lattice structure has meshes of a size smaller than 1 mm. Preferably the mesh sizes are smaller than 500 μm. Depending on the field of application, i.e. the level of contamination of the process medium P, it is possible to select smaller or larger mesh sizes. Small meshes have the effect that dirt (especially membrane-damaging substances) is better kept away from the sensitive unit 13, but the inflow to the sensitive unit 13 is reduced. This results in a longer service life, i.e. operating time of the sensor 10, but this also results in a longer response time. Larger meshes have the effect that less dirt is kept away from the sensitive unit 13, but the inflow to the sensitive unit 13 is increased, and therefore a shorter service life but a shorter response time is obtained.

The membrane unit 24 is preferably porous or has capillaries and small holes which hinder the diffusion and flow of ions in the membrane unit 24. The membrane unit 24 preferably comprises textile or is preferably designed as textile. For example, the membrane unit 24 is designed as a nylon stocking.

The membrane unit 24 is preferably suitable for reducing the transport of ions through the membrane unit 24, which is made possible by the lattice structure. The membrane unit 24 is preferably high-impedance and preferably has a fluid layer to the sensitive unit 13 when the membrane unit 24 is arranged in the process medium.

The textile is made from natural fibers or chemical fibers, for example. The textile is, for example, the linear textile structures made therefrom, such as yarns, twines and ropes, the flat textile structures such as woven fabrics, knitted fabrics, braids, sewn fabrics, nonwovens and felts, and the spatial textile structures (body structures) such as textile tubes, stockings or textile semi-finished products for reinforced plastic components. For example, textiles also include those finished products which, using the products mentioned above, are brought into a saleable condition by means of assembly, opening and/or other operations for forwarding to the processor, retail or the final consumer.

According to an alternative embodiment of the present disclosure, the membrane unit 24 is manufactured using a 3D printing process or a multi-component injection molding process and comprises, for example, rubber, PVC or other plastics as the material.

The membrane unit 24 preferably has an elasticity greater than hard rubber, in particular a modulus of elasticity <5 GPa.

The secondary fastening unit 25 is suitable for fastening the membrane unit 24 to the rod-shaped sensor 10. The secondary fastening unit 25 is suitable for being releasably fastened to the primary fastening unit 15. According to one embodiment of the present disclosure, the secondary fastening unit 25 is formed integrally with the membrane unit 24. This means that in the case where the membrane unit 24 is a textile, the secondary fastening unit 25 is, for example, woven into the textile or is part of the textile. In particular, if the primary fastening unit 15 comprises a hook element, these hooks can engage in the lattice structure of the textile. The hook elements are, for example, Velcro hooks made of plastic, or metal hook elements.

According to one embodiment of the present disclosure, the secondary fastening unit 25 is designed as an O-ring. This embodiment is particularly useful when the primary fastening unit 15 is designed as the groove described above. This allows the membrane unit 24 to be securely attached to the sensor body 11 by the secondary fastening unit 25. Instead of a rubber O-ring, it is also possible to use, for example, a tension ring or a metal clamp or a cable tie or elastic band. Thanks to the detachable secondary fastening unit 25, it is possible to remove the membrane unit 24 without great expenditure of time, for example for cleaning or calibrating the sensor 10, to reattach it after cleaning the sensitive unit 13, or to replace it with a new fastening unit 25.

According to one embodiment of the present disclosure, the protective membrane system 20 further comprises an intermediate layer 26. The intermediate layer 26 is suitable, for example, to be arranged between the membrane unit 24 and the rod-shaped sensor 10. According to an alternative embodiment of the present disclosure, the intermediate layer 26 can be fastened to the membrane unit 24. This makes it possible to fasten the intermediate layer between the sensitive unit 13 and the membrane unit 24, i.e. on the inside of the membrane unit 24.

The intermediate layer 26 has a lattice structure like the membrane unit 24, but is more tightly meshed than the membrane unit 24 so that it regulates the inflow, and the resilient membrane unit 24 is responsible in particular for the correct fit of the intermediate layer 26. For example, the intermediate layer 26 is made of fleece, felt, or other membrane materials used for the filtration of aqueous media or another similar textile material.

The intermediate layer 26 makes it possible to decouple the membrane unit 24 from the sensitive unit 13. The term decoupling here refers in particular to both chemical and electrochemical decoupling, so that harmful substances do not pass directly from the membrane unit 24 into the sensitive unit 13, and no potentials forming in the membrane unit 24 are passed on to the sensitive unit 13 by ion conduction. This decoupling is achieved by the fact that the intermediate layer 26 consists of a material which forms strong phase boundaries to 13 and 24 and ideally has good ionic conductivity so that all solution potentials are brought to the potential of the process medium. Thus, for example, a tissue paper soaked with process water can act as an intermediate layer 26 for a nitrate ISE.

If the sensor unit 100 has an intermediate layer 26, the membrane unit 24 and the sensitive unit 13 are preferably made of a similar or identical material.

Next, test results of the protective membrane system 20 described above when used with an ISE electrode shown in FIG. 1 follow.

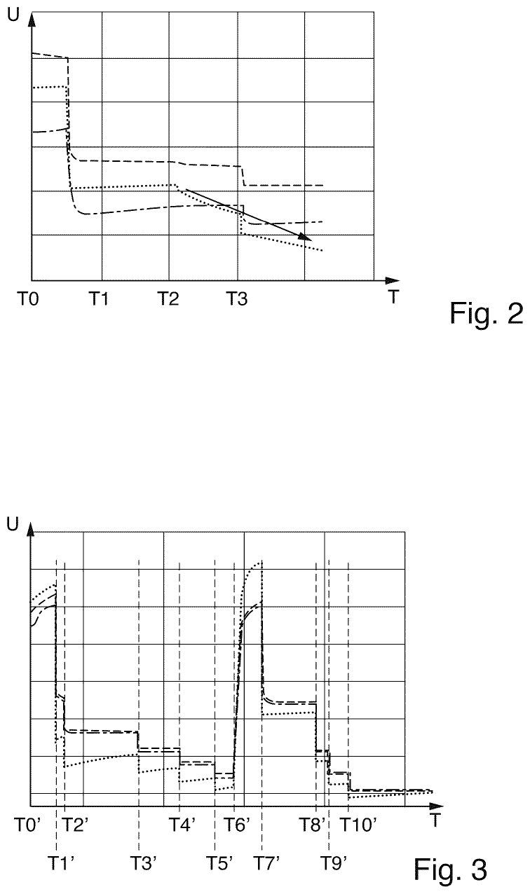

FIG. 2 shows a comparison of different ISE electrodes and ISE sensors. A first sensor was tested without the protective membrane system 20 according to the present disclosure, and its measurement curve is shown in dotted lines in the graph. A second sensor was tested with the protective membrane system 20 according to the present disclosure (in this specific case a piece of nylon stocking), and its measurement curve is shown in the graph with a dashed line. A third sensor was tested with the protective membrane system 20 according to the present disclosure and additionally with the intermediate layer 26 described above (in this specific case a piece of cellulose cloth), and its measurement curve is shown in the graph as a dash-dotted curve. In FIG. 2, the abscissa axis is the time axis T, and the ordinate axis is the voltage U measured at the ISE sensor. In the embodiment, this is a nitrate-selective ISE; in this ISE, the voltage U decreases when the nitrate concentration increases.

Referring to FIG. 2, initially, i.e. at time T0, the three sensors were run in analyte-free water. Subsequently, ammonium nitrate was added at time T1, followed at time T2 by surfactant (SDS=sodium lauryl sulfate or sodium dodecyl sulfate which serves as a model substance for a membrane-damaging substance that may be present in the wastewater) and followed again, i.e. at time T3, by ammonium nitrate.

In FIG. 2, it is easy to see how, immediately after the addition of the SDS, i.e. at time T2, the unprotected electrode, i.e. the first sensor without a protective membrane system 20, begins to drift (dotted curve), which is indicated by the black arrow. This means that the voltage measured at the second sensor changes even without a change in the analyte concentration; in this case, it decreases. Likewise, in the case of the second sensor, i.e. the sensor with the protective membrane system 20, and in the case of the third sensor, i.e. the sensor with the protective membrane system 20 and an intermediate layer 26, no noticeable distortion or drift of the measuring voltage can be detected. It can be seen that, after the addition of the SDS (at time T2), the voltage of the two electrodes with the protective membrane system 20 stabilizes very quickly and then does not change, in contrast to the sensor without protection. The response to analyte addition (at time T3) is the same level for all sensors, but the sensors with the protection system 20 react somewhat slower. This proves that the protective membrane system 20 efficiently protects against harmful chemical influences and significantly reduces the drift of the sensor 10, and at the same time only insignificantly attenuates the temporal response of the measuring signal.

FIG. 3 shows another test with the three sensors mentioned above. The electrodes were left in a SDS-containing solution for several days and then simultaneously immersed in an analyte-free solution (at time T0′). This means that before time T0′ the unprotected electrode has become saturated with SDS and has drifted accordingly. Between time T0′ and time T1′ the electrodes respond to the decrease in analyte concentration. At times T1′ and subsequently at T2′, T3′, T4′ and T5′, analyte (in this case nitrate) was added at defined concentrations. It can be seen that the electrodes respond very quickly to the change in the analyte concentration. The voltage jump that is triggered by the additions is also the same for all electrodes. This means that the slopes of the electrodes are comparable. However, the electrode without the protection system 20 also shows a significant change in the measuring voltage between the additions (dotted curve). In contrast, electrodes with the protection system 20 remain stable and change their voltage only as desired at the times of addition. The drift of the unprotected electrode in SDS-free water results from the reverse process of leaching (in this case, the SDS that has accumulated in the electrode is washed out again) and the distribution of the SDS within the membrane. In this case, this leads to an increase in voltage. At time T6′, the electrodes are again immersed in fresh SDS-free and analyte-free solution. It can be seen that the unprotected electrode has recovered by washing out the SDS. It shows a larger voltage in the analyte-free medium (immediately before T7′), and the drift between the new additions (T7′, T8′, T9′, T10′) is significantly lower. It turns out that the drift of the electrodes protected with 20 is significantly lower, and that they respond just as well to a change in the analyte concentration.

The response of the unprotected electrode and the protected electrodes to analyte addition is almost equal in this test. If the drift between the additions is calculated from the measured values, an almost ideal slope close to the Nernst slope is obtained for all electrodes. It should be noted that in practice, it is not possible to calculate out the drift, and therefore the drift inevitably leads to large measurement errors.

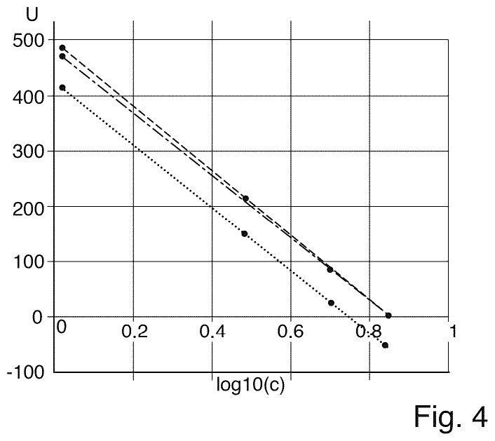

For illustration, FIG. 4 shows a plot of the slope for the three electrodes for the three sensors tested in the test described above. For plotting the slope of the electrode without the protective membrane system 20, only the jumps were used and added up.

What follows now is a detailed explanation of the chemical processes or charging processes through ion migration between the process medium P, protective membrane system 20, sensitive element 13 and electrolyte 17.

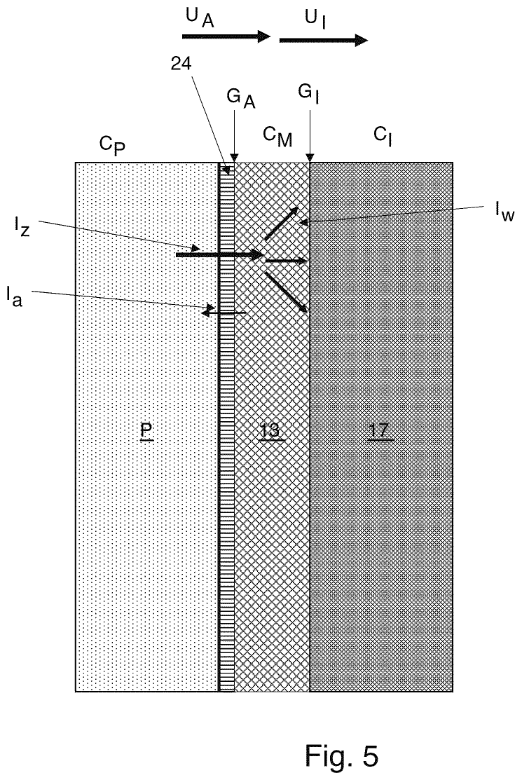

FIG. 5 shows the schematic structure of the layers of an ISE electrode.

Shown in FIG. 5, an ion migration is depicted from the process medium P through the protective membrane system 20 into the sensitive element 13 is represented by Iz. Ion migration from the sensitive element 13 through the protective membrane system 20 into the process medium P is represented by Ia. A migration from the sensitive element 13 into the electrolyte 17 is represented by Iw.

The sensitive element 13 is designed to contain cations which cannot migrate out of the sensitive element 13 due to their extremely low water solubility. In order to compensate for this excess charge, anions migrate into the sensitive element 13. In the case of a nitrate ISE sensor, these are the nitrate anions.

The voltage that is measured at an ISE is composed of two so-called phase boundary voltages UA and UI, i.e. voltages or potentials that are present at so-called phase boundaries. The phase boundaries are the inner and outer surfaces of the sensitive element 13, i.e., as shown in FIG. 5, the outer phase boundary GA between the protective membrane system 24 (wherein the protective membrane system 24 is impregnated with process medium during use) and the sensitive element 13, as well as the inner phase boundary GI between the sensitive element 13 and the inner electrolyte 17. The two voltages UA and UI across these interfaces are each proportional with an offset to the logarithm of the concentration ratios cP, cM in the two adjacent phases. This can be formulated as follows:

$${U}_{A} \sim log ( \frac{{c}_{P}}{{c}_{M}} ) + const a = log ( {c}_{P} ) - log ( {c}_{M} ) + const a$$

$${U}_{I} \sim log ( \frac{{c}_{P}}{{c}_{M}} ) + const b = log ( {c}_{M} ) - log ( {c}_{I} ) + const b$$

wherein cp is the concentration of the analyte in the process medium P, wherein cl is the concentration of the analyte in the inner electrolyte 17, and wherein cM is the concentration of the analyte in the sensitive element 13. Since the actual relevant voltage is the sum of the two voltages, the Nernst equation is obtained as follows:

$${U}_{AI} = {U}_{A} + {U}_{I} = log ( \frac{{c}_{P}}{{c}_{I}} ) + ( c o nst a + const b )$$

It can be seen that the usual Nernst equation only applies if the concentration of the analyte ions (nitrate ions) within the sensitive element 13 on the inside and outside (near GA and GI) is the same, or at least the ratio is constant over a longer period of time. Only in this case do the two logarithmic terms log(cM) cancel each other out, and the term (const a+const b) also disappears (if a=−b) or becomes a constant (the zero point or the reference voltage).

If anions from the process enter the sensitive element 13, which have a higher affinity to the sensitive element 13 (for example lipids or surfactants in the example of SDS) than the nitrate ions, they displace the nitrate ions and change cM at the process-side surface GA of the sensitive element 13 (electroneutrality is assumed). This causes a drift of the electrode. If so many ions are displaced from the surface that cM becomes very small, cM changes during the potential adjustment, and the electrode becomes sluggish and loses its slope.

It is therefore necessary to keep the concentration of these interfering anions near the interface GA as small as possible. The concentration is increased by entry of ions through GA, and decreased by exit from GA (hardly possible) and further migration towards GI (quite possible). The protection system 20 prevents all ions from entering the sensitive element 13 by slowing down the diffusion. This initially only hinders the entry and exit of the interfering ions and reduces the drift. However, since the further migration of the interfering ions away from the interface GA towards the interface GI is not hindered, the concentration of the interfering ions near GA remains small even after a longer time. A significant interference only occurs when the entire sensitive element 13 is enriched with the interfering anions. Since the access is also reduced by the protective membrane system 20, the saturation of the sensitive element 13 is also greatly delayed, and the drift over the application period is greatly reduced.

1. A protective membrane system for a rod-shaped sensor, comprising:
a membrane unit which is resilient and has a lattice structure,
a secondary fastening unit which is suitable for fastening the membrane unit to a rod-shaped sensor.

2. The protective membrane system according to claim 1, wherein the lattice structure has meshes of a size less than 1 mm.

3. The protective membrane system according to claim 1, wherein the membrane unit comprises textile.

4. The protective membrane system according to claim 1, wherein the secondary fastening unit comprises an O-ring or a hook element.

5. The protective membrane system according to claim 1, wherein the protective membrane system further comprises an intermediate layer which is suitable for being arranged between the membrane unit and the rod-shaped sensor.

6. The protective membrane system according to claim 1, wherein the membrane unit is suitable to reduce ion transport through the membrane unit.

7. A sensor unit comprising:
a sensor having a sensor body which extends along an axis and has a first end, wherein a sensitive unit is arranged at the first end, and the first end is suitable for being immersed in a process medium, and
a protective membrane system including a membrane unit which is resilient and has a lattice structure, a secondary fastening unit which is suitable for fastening the membrane unit to a rod-shaped sensor,
wherein the protective membrane system is arranged at the first end and fastened to the sensor body such that the sensitive unit is covered by the protective membrane system towards the process medium.

8. The sensor unit according to claim 7, wherein the sensor body has a primary fastening unit which is complementary to the secondary fastening unit of the protective membrane system.

9. The sensor unit according to claim 8, wherein the primary fastening unit is a groove in the sensor body running around the axis, and the secondary fastening unit is designed as an O-ring.

10. The sensor unit according to claim 8, wherein the primary fastening unit comprises a hook element, and the secondary fastening unit is formed integrally with the membrane unit.

11. The sensor unit according to claim 7, wherein the sensor comprises an ion-selective electrode, and has an electrolyte in the sensor body, and has a discharge line arranged in the electrolyte, wherein the sensitive unit is an ion-selective membrane which is in direct contact with the electrolyte.
